(19) United States
(12) Patent Application Publication
(10) Pub. No.: US 2007/0273511 A1
(43) Pub. Date: Nov. 29, 2007

(54) WIRELESS SYNCHRONIZATION SYSTEMS AND METHODS

(75) Inventor: Thomas E. Clary, Springfield, OH (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/420,075

(22) Filed: May 24, 2006

(51) Int. Cl. G08B 13/00

(52) U.S. Cl. 340/565

(57) ABSTRACT

A wireless synchronization system. The system includes a plurality of nodes. Each node includes a radio frequency (RF) transceiver, one or more strobe lights and a controller in signal communication with the RF transceiver and the one or more strobe lights. The controller controls operation of the one or more strobe lights based on a synchronization message wirelessly received by the RF transceiver and generates and transmits via the RF transceiver a follow-on synchronization message based on the received synchronization message.

### BACKGROUND OF THE INVENTION

The Federal Aviation Administration (FAA) regulates the signaling demands of various types of man-made structures in order to visually warn pilots of their location. If a plurality of man-made structures having similar height and configuration, such as windmills, are dispersed over an area of land, the FAA requires that each structure includes a strobe light and that the strobe lights are synchronized. It can be difficult and expensive to synchronize a great many strobe lights especially if one set of structures is owned by a first entity and an adjacent set of structures is owned by a second entity. In this case, there would have to be coordination between the two entities as well as wiring between all the structures in order for synchronization signals to coordinate the operation of all the strobe lights.

Therefore, there exists a need to efficiently and inexpensively control synchronization of strobe lights across a plurality of structures.

### SUMMARY OF THE INVENTION

The present invention provides a wireless synchronization system. The system includes a plurality of nodes. Each node includes a radio frequency (RF) transceiver, one or more strobe lights and a controller in signal communication with the RF transceiver and the one or more strobe lights. The controller controls operation of the one or more strobe lights based on a synchronization message wirelessly received by the RF transceiver and generates and transmits via the RF transceiver a follow-on synchronization message based on the received synchronization message.

The controller assumes master node operations by comparing priority information of the node to priority information included within any received synchronization messages.

The follow-on synchronization message includes a generation value that is one greater than a generation value included in the received synchronization message.

The nodes periodically receive one of the synchronization message or the follow-on synchronization message. The synchronization messages are used to synchronize the period and phase of a timer local to each node. The timer component controls operation of the strobe lights so the flashing rates will remain synchronized even if the node fails to periodically receive the synchronization message.

### BRIEF DESCRIPTION OF THE DRAWINGS

The preferred and alternative embodiments of the present invention are described in detail below with reference to the following drawings:

FIG. 1 illustrates a schematic diagram of a plurality of nodes formed in accordance with an embodiment of the present invention;

FIGS. 2 and 3 illustrate an example process performed by the plurality of nodes shown in FIG. 1;

FIGS. 4-6 illustrate synchronization message propagation within a constellation of nodes; and

FIG. 7 illustrates an example of timer synchronization that occurs in an embodiment of the present invention.

### DETAILED DESCRIPTION OF THE PREFERRED EMBODIMENT

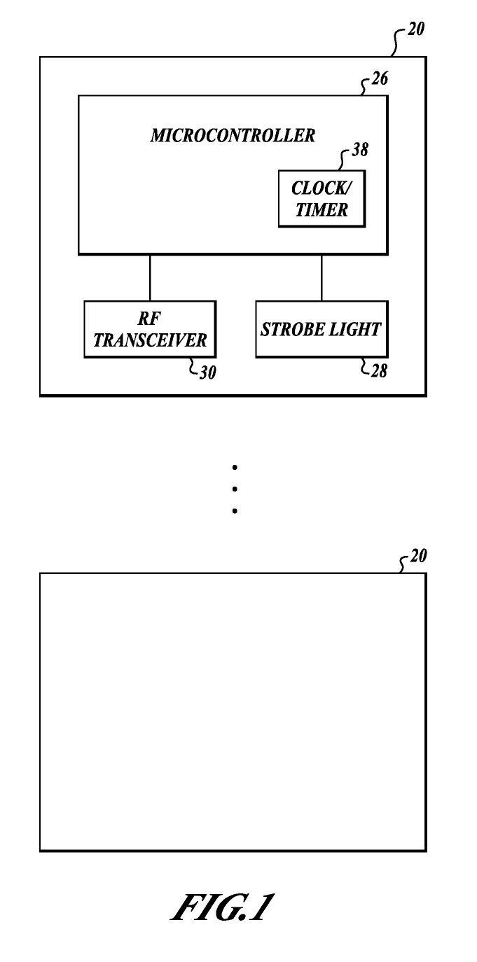

FIG. 1 illustrates a plurality of nodes 20 that are located in a certain area and require synchronization.

Each node 20 includes a microcontroller 26, a strobe light 28, and a radio frequency (RF) transceiver 30. The microcontroller 26 is in signal communication with the RF transceiver 30 and the strobe light 28. The microcontroller 26 includes a clock/timer circuit 38 that controls the timing operation of the strobe light 28 based on synchronization messages received by the RF transceiver 30 that are transmitted to the microcontroller 26. The microcontroller 26 may also generate synchronization messages that are transmitted to other nodes 20 via the RF transceiver 30. The RF transceiver 30 uses any of a number of different wireless protocols, such as IEEE 802.15.4.

Example of nodes 20 include windmills, radio or wire transmission towers, or other devices that include devices like strobe lights that must be synchronized.

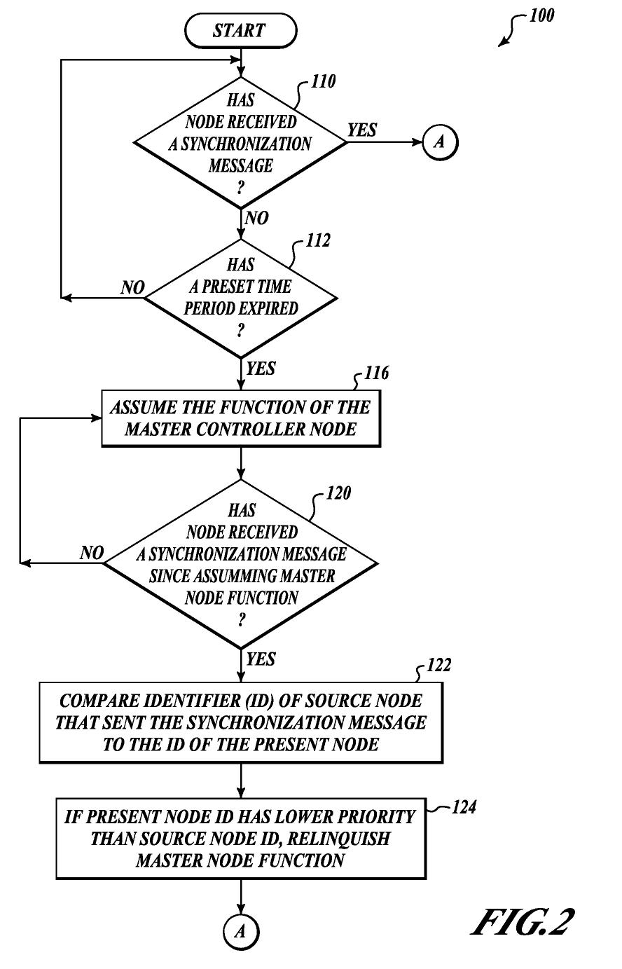

FIG. 2 illustrates an example process 100 that describes a start-up scenario for the nodes 20. First, at a decision block 10, a node 20 determines if it has received a synchronization message. If the node 20 has received a synchronization message, then it continues normal operation as will be described in more detail below. If the node 20 has not received a synchronization message, then at a decision block 112, the node 20 determines if a pre-set time period has expired. If the pre-set time period has expired, the node 20 assumes the function of the master controller node, see block 116. Master controller node operation will be described in more detail below.

Next, at a decision block 120, the node 20 determines if it has received a synchronization message since assuming the master node function. If the node 20 has not received a synchronization message, then it continues performing as the master node. However, if a synchronization message has been received, then at a block 122, the node 20 compares an identifier (ID) of the node (source node) that sent the synchronization message to its ID. At a block 124, if the node's ID has a lower priority than the ID of the source node, the node relinquishes the master node function and then continues operation as normal.

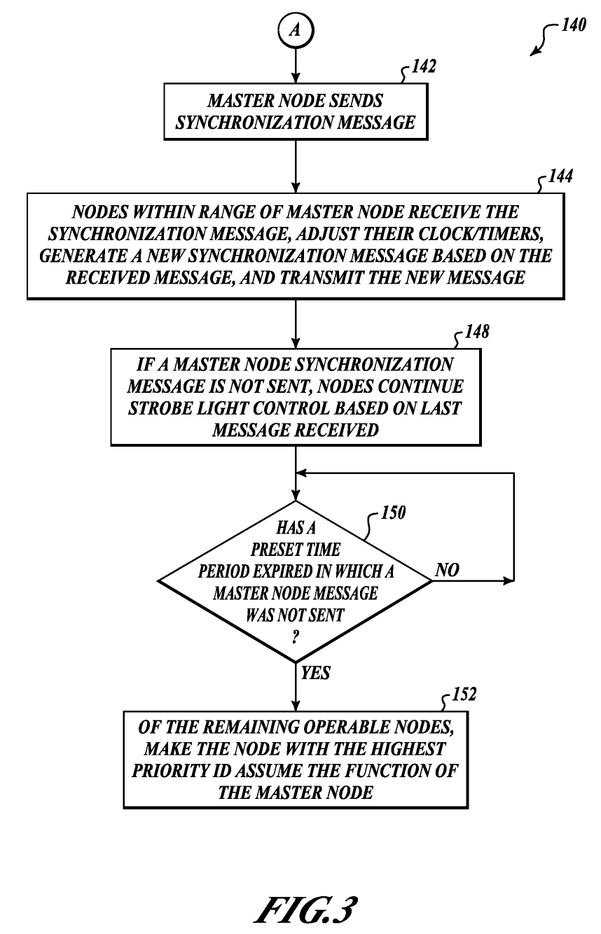

FIG. 3 illustrates an example process 140 as continued from the process 100 shown in FIG. 2. First, at a block 142, the master node wirelessly sends a synchronization message. Next, at a block 144, the nodes within wireless communication range of the master node receive the wirelessly sent synchronization message. After the nodes receive the synchronization message, they adjust their clock/timer circuits 38 and generate a follow-on synchronization message based on the received master node synchronization message. These nodes then transmit the follow-on synchronization message wirelessly via their RF transceiver 30. At a block 148, if a master node synchronization message is not sent and received by the node within the range of the master node, all nodes continue control of their respective strobe lights 28 based on the last synchronization message received. At a decision block 150, a determination is made of whether a pre-set time period has expired in which the master node synchronization message has not been sent or received. If the time period has not expired, then the process waits for the expiration of the time period until a master node synchronization message is received. If the time period has expired, then at a block 152, it is assumed that the master node is no longer fully operational and of the remaining nodes, a determination is made as to which node has the highest priority node ID. The node with the highest priority node ID of the remaining nodes assumes the function of the master node and the process returns to decision block 120 as shown in FIG. 2. The node ID will be the 64 bit Source Node address that is uniquely defined during manufacturing of the controller.

Table 1 illustrates an example of the information that is included in a synchronization message.

TABLE 1

| | | |
|---|---|---|
| Source Node address | 64 bits | The fixed address assigned to the |
| | | transmitting node |
| Master Node Address | 64 bits | The fixed address of the master |
| | | node sending out the generation |
| | | 0 message |
| Sequence Number | 8 bits | A modulo 256 number to identify each |
| | | sync message |
| Generation Number | 8 bits | Indicates how many times this |
| | | message has propagated |
| Flash mode | 8 bits | Indicates nominal flash rate, |
| | | day/night, etc. |

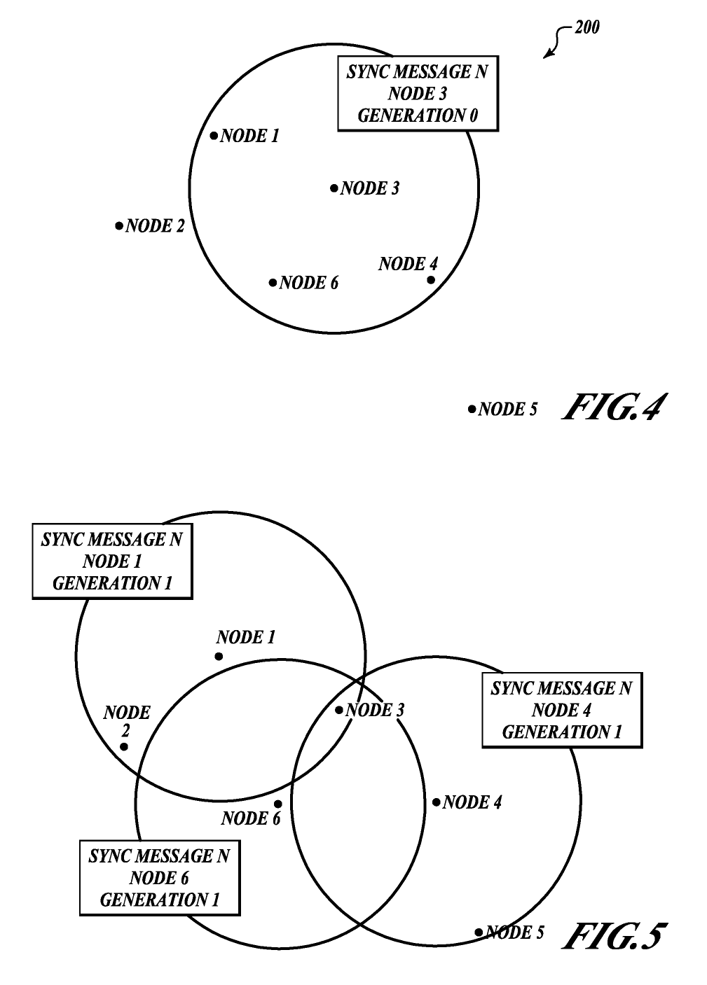

As shown in FIG. 4, a constellation 200 of the nodes is dispersed about an area. Node 3 has been designated as the master node. Because node 3 is the master node, it generates a generation 0 synchronization message and wirelessly transmits it via the RF transceiver 30. As shown in FIG. 5, the nodes within range of node 3, nodes 1, 4, and 6, perform timer synchronization based on the received synchronization message and then re-transmit the synchronization message inserting their source node address (ID) and increasing the generation number by 1.

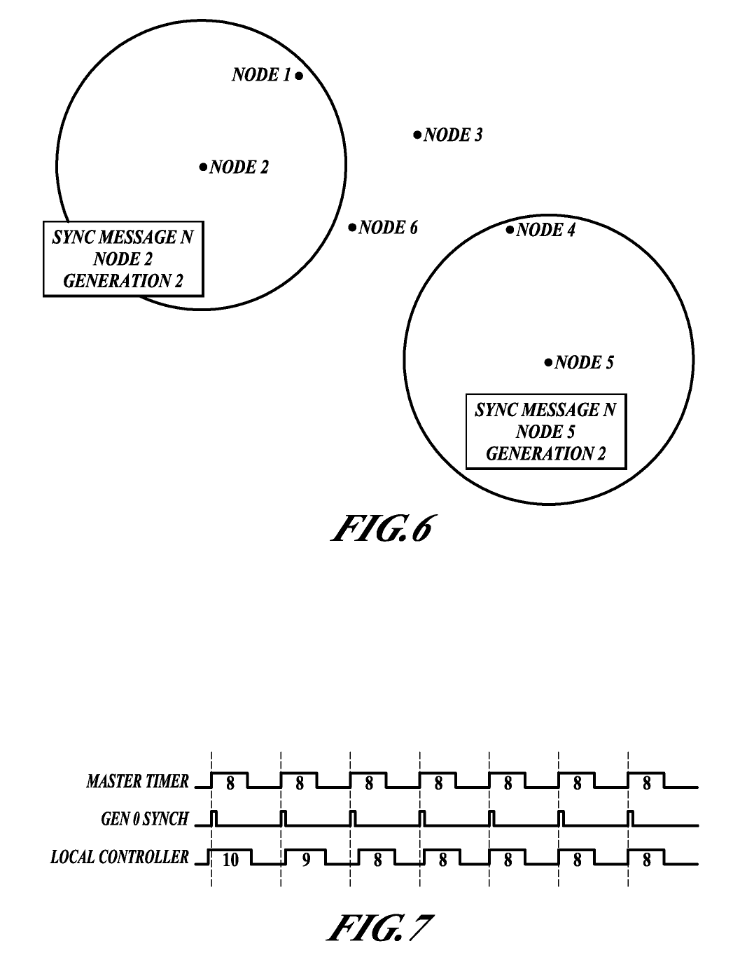

As shown in FIG. 6, the remaining nodes 2 and 5 receive synchronization messages from nodes 1 and 4, respectively. The nodes 2 and 5 then prepare synchronization message for transmission by increasing the generation number by 1 and inserting their address information.

The local timer circuits 38 are adjusted based on the time the synchronization message was received taking into account the latency (knowledge of transmission time and Generation Number (Table 1) in message) associated with that message. The first valid message having the lowest Generation Number is preferably used because it has the lowest latency and therefore will be most accurate. The phase of the flashing will be adjusted based off of a single message while the period will be adjusted based on the time between synchronization messages. The controller will utilize a digital phase lock loop algorithm to synchronize the local timers with the master timer. The timer adjustments are filtered so there is never an abrupt change in the flashing from a set of lights. FIG. 7 illustrates the adjustment process.

Table 1 includes the address of the master node. This is used for arbitration as the system potentially starts up with multiple masters or when a master drops offline.

The system will support multiple flash rates by having the master indicate the selected flash rate. The local controller will proportionally change its timer period for the new rate and then fine tune using the normal adjustment algorithm.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A wireless strobe light flash synchronization system comprising:
a plurality of nodes, each node comprising:
a radio frequency (RF) transceiver;
one or more strobe lights; and
a controller in signal communication with the RF transceiver and the one or more strobe lights, the controller comprising:
a timer component for controlling operation of the one or more strobe lights based on a synchronization message wirelessly received by the RF transceiver; and
a component for generating and transmitting via the RF transceiver a follow-on synchronization message based on the received synchronization message.

2. The system of claim 1, wherein the controller comprises a component for assuming master node operations by comparing priority information of the present node to priority information included within any received synchronization messages.

3. The system of claim 2, wherein the node assumes master node operations if the priority information of the node is greater than the priority information included within the received synchronization messages.

4. The system of claim 1, wherein the follow-on synchronization message includes a generation value that is one greater than a generation value included in the received synchronization message.

5. The system of claim 1, wherein the nodes periodically receive the synchronization message and the timer component controls operation of the strobe lights based on the received synchronization message.

6. The system of claim 5, wherein the timer component controls operation of the strobe lights based on the last received synchronization message, if the node fails to periodically receive the synchronization message.

7. The system of claim 6, wherein one of the plurality of nodes that was previously determined to include the highest priority of the still operating nodes assumes master node operations, if the node fails to receive the synchronization message after a predefined period of time has expired.

8. The system of claim 1, wherein the plurality of nodes includes windmills.

9. A method for synchronizing strobe lights at a plurality of nodes, each node having one or more strobe lights, the method comprising:
receiving a synchronization message at a controller via a radio frequency (RF) transceiver;
controlling operation of the one or more strobe lights based on the received synchronization message;
generating a follow-on synchronization message based on the received synchronization message; and
transmitting the generated follow-on synchronization message via the RF transceiver.

10. The method of claim 9, further comprising:
comparing priority information of the present node to priority information included within the received synchronization message; and
assuming master node operations if the priority information of the node is greater than the priority information included within the received synchronization messages.

11. The method of claim 9, wherein the follow-on synchronization message includes a generation value that is one greater than a generation value included in the received synchronization message to account for message latency.

12. The method of claim 9, wherein the node periodically receives the synchronization message, further comprising controlling operation of the strobe lights based on the received synchronization message.

13. The method of claim 12, wherein controlling operation of the strobe lights controls operation of the strobe lights based on the last received synchronization message, if the node fails to periodically receive the synchronization message.

14. The method of claim 9, further comprising:
determining which of the active nodes has the highest priority if the synchronization message has not been received after a predefined period of time has expired,
wherein the node determined to have the highest priority generates a synchronization message and transmits the generated synchronization message.
